(19) United States
(12) Patent Application Publication
(10) Pub. No.: US 2010/0161888 A1
(43) Pub. Date: Jun. 24, 2010

(54) Data storage system with non-volatile memory using both page write and block program and block erase

(75) Inventor: David Eggleston, San Jose, CA (US)

Correspondence Address: UNITY SEMICONDUCTOR CORPORATION, 255 SANTA ANA COURT, SUNNYVALE, CA, 94085-4511, US

(73) Assignee: UNITY SEMICONDUCTOR CORPORATION, Sunnyvale, CA (US)

(21) Appl. No.: 12/653,938

(22) Filed: Dec. 18, 2009

Related U.S. Application Data
(60) Provisional application No. 61/203,440, filed on Dec. 22, 2008.

(51) Int. Cl. G06F 12/02

(52) U.S. Cl. 711/103; 711/E12.008

(57) ABSTRACT

An optimized data storage system including non-volatile re-writeable memory having both block program and erase and full or partial page write is disclosed. A memory controller of the system can use block data operations for large data transfers, and page data operations for small data transfers. Page data operations in the non-volatile re-writeable memory do not require block rewrites. One or more layers of the non-volatile re-writeable memory can be fabricated BEOL as two-terminal cross-point memory arrays that are fabricated over a substrate including active circuitry fabricated FEOL. Some or all of the active circuitry can be electrically coupled with the one or more layers of two-terminal cross-point memory arrays to perform data operations on the arrays, such as the block program and block erase and/or full or partial page writes. The arrays can include a plurality of two-terminal memory cells.

### FIELD OF THE INVENTION

The present invention relates generally to data storage technology. More specifically, the present invention relates to block and page data operations on non-volatile re-writeable memory.

### BACKGROUND

In some conventional data storage systems, there exists an imbalance between the minimum data unit from the operating system (OS), the minimum programming unit, and the minimum erase unit. For example, in multi-level cell (MLC) NAND FLASH, a write data unit from the OS is a sector (typically 512 Bytes), a memory program data unit is 1 page (typically 2 KB), and a memory erase data unit is 1 block (typically 128 KB or more). Further, in MLC NAND FLASH, full page writes must be performed in sequence from the first page in the block to the last page in the block. No out of sequence pages are allowed and no partial pages are allowed.

In FIG. 1, a conventional data storage system 100 includes a host system 110 including an OS 111 running on the host 110 and a sector 113 for write data which typically has a data unit size of 512 B. Sector 113 can include a register or buffer configured to store and output a sector of data over Host I/F 115 in response to commands or actions of the host system 110. A controller 120 (e.g., a memory controller) is in communication with the host 110 via host interface (Host I/F) 115 and in communication 125, 170, 171, and 172 with a plurality of memory devices 160, 161, 162, . . . via a memory interface (MEMORY I/F) 140. The memory devices 160, 161, 162, . . . can represent MLC NAND FLASH memory or some other type of non-volatile re-writeable memory, such as hard disk drives (HDD) or FLASH based solid state drives (SDD), for example. An example of how data units are partitioned in one of the plurality of memories, memory 160, is shown in greater detail and depicts a typical block erase size 160BE of ≧128 KB and a typical page program size 160PP of 2 KB. The values given in FIG. 1 for the data units for the sector 113, the page program size 160PP, and the block erase size 160BE are just examples and examples of other sizes for data units that can be used in the conventional data storage system 100 include but are not limited to a cluster or 4 KB for sector 113, 256 KB or 512 KB for block erase size 160BE, and 4 KB or 8 KB for page program size 160PP.

As the industry increases page size (e.g., 160PP) and block size (e.g., 160BE), the aforementioned imbalance is getting worse because the OS sector size (e.g., sector 113) stays the same (e.g., 512 B) or at least stays very small relative to the increases in page and block sizes the industry is adopting. For MLC NAND FLASH, the minimum programming unit size is 2 KB and the minimum block erase unit size is 128 KB. Consequences of the imbalance between OS sector size and page and block sizes can include dramatically reduced write speed when writing small files to a data storage device (e.g., a non-volatile memory such as FLASH). The small file writes (e.g., a file size that is less than the erase block size of 128 KB) occur often when the OS 111 is updating file allocation tables (FAT). FAT entries are critical for locating the data when read back of data is required. Although sizes for pages and blocks in FLASH memory can vary, the following are examples of common data sizes for NOR and NAND FLASH memory. Typical NOR FLASH block sizes are 64 KB, 128 KB, or 256 KB. For NOR FLASH, random access reads and programming are done in multiple byte or word units so that page operation terminology (e.g., page size) does not apply to NOR FLASH. Typical NAND FLASH block and page sizes vary over a range of: 512 KB block size with 128 pages with 4096 bytes per page; 256 KB block size with 64 pages with 4096 bytes per page; 128 KB block size with 64 pages with 2048 bytes per page; and 16 KB block size with 32 pages with 512 bytes per page.

It is desirable to improve system performance by decreasing the time and complexity in writing small file sizes. Additionally, it is also desirable to improve system reliability by decreasing the time and complexity in writing the FAT entries. Power loss during FAT entry updates are a difficult problem for systems using MLC NAND FLASH. Furthermore, since the number of data moves wears out the FLASH memory, having the capability to reduce the number of data moves increases system reliability and longevity.

There are continuing efforts to improve data operations on non-volatile re-writable memory technologies.

### BRIEF DESCRIPTION OF THE DRAWINGS

The invention and its various embodiments are more fully appreciated in connection with the following detailed description taken in conjunction with the accompanying drawings, in which:

FIG. 1 depicts a conventional data storage system in communication with a host system;

FIG. 2 depicts block and page data operations on memory according to the present invention;

FIG. 3 depicts a data storage system for performing block and page data operations on memory according to the present invention;

FIG. 4A depicts an integrated circuit including memory cells disposed in a single memory array layer or in multiple memory array layers and fabricated over a substrate that includes active circuitry fabricated in a logic layer;

FIG. 4B depicts a cross-sectional view of an integrated circuit including a single layer of memory fabricated over a substrate including active circuitry fabricated in a logic layer;

FIG. 5A depicts a top plan view of an exemplary data storage system including a memory controller IC and a plurality of non-volatile memory IC's mounted on a substrate;

FIG. 5B depicts a cross-sectional view of the data storage system depicted in FIG. 5A;

FIG. 5C depicts a cross-sectional view of another exemplary data storage system in which the memory controller is integrated with one of the non-volatile memory IC's;

FIG. 5D depicts a cross-sectional view of yet another exemplary data storage system in which the memory controller and multiple layers of non-volatile memory are integrated into a single IC;

FIG. 5E depicts a cross-sectional view of yet another exemplary data storage system in which the memory controller and a partitioned non-volatile memory arrays are integrated into a single IC; and

FIG. 6 depicts a top plan view of an exemplary wafer processed FEOL to form a plurality of base layer die including active circuitry and the same wafer subsequently processed BEOL to form one or more layers of memory directly on top of the base layer die.

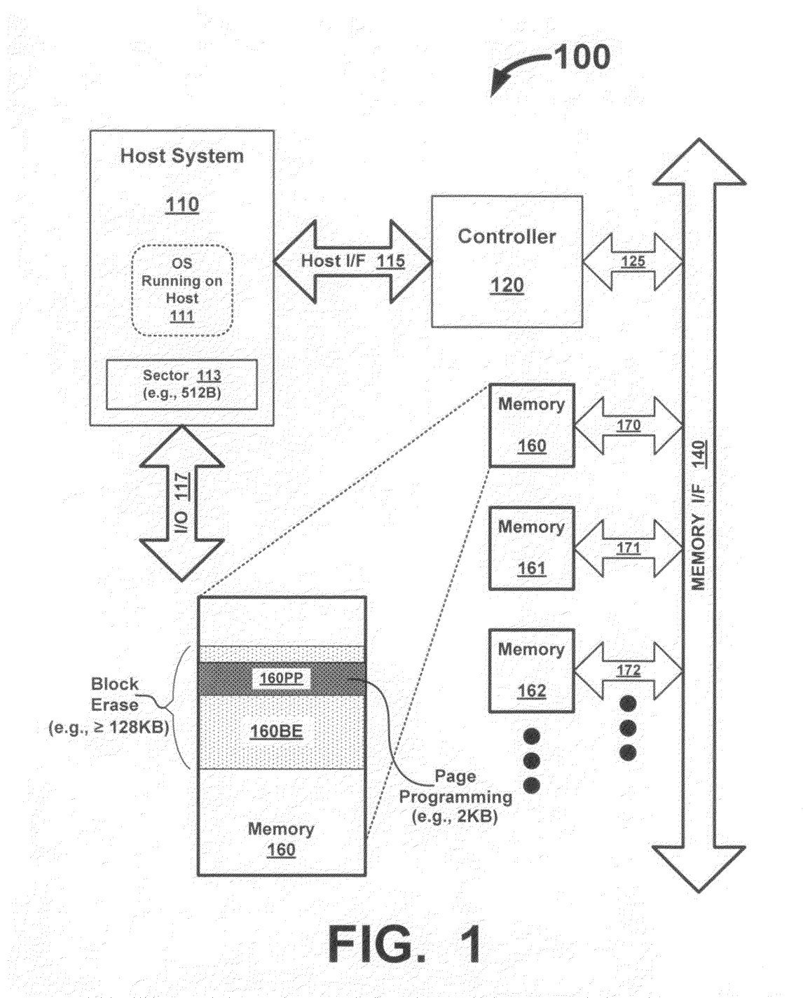

Although the above-described drawings depict various examples of the invention, the invention is not limited by the depicted examples. It is to be understood that, in the drawings, like reference numerals designate like structural elements. Also, it is understood that the drawings are not necessarily to scale.

### DETAILED DESCRIPTION

Various embodiments or examples of the invention can be implemented in numerous ways, including as a system, a process, an apparatus, or a series of program instructions on a computer readable medium such as a computer readable storage medium or a computer network where the program instructions are sent over optical, electronic, or wireless communication links. In general, operations of disclosed processes can be performed in an arbitrary order, unless otherwise provided in the claims.

A detailed description of one or more examples is provided below along with accompanying figures. The detailed description is provided in connection with such examples, but is not limited to any particular example. The scope is limited only by the claims, and numerous alternatives, modifications, and equivalents are encompassed. Numerous specific details are set forth in the following description in order to provide a thorough understanding. These details are provided as examples and the described techniques can be practiced according to the claims without some or all of the accompanying details. For clarity, technical material that is known in the technical fields related to the examples has not been described in detail to avoid unnecessarily obscuring the description.

New memory structures are possible using third dimensional memory arrays that include third dimensional two-terminal memory cells that can be arranged in a two-terminal, cross-point memory array as described in U.S. patent application Ser. No. 11/095,026, filed Mar. 30, 2005, entitled “Memory Using Mixed Valence Conductive Oxides,” and published as U.S. Pub. No. US 2006/0171200 A1 on Aug. 3, 2006, already incorporated herein by reference in its entirety and for all purposes. In at least some embodiments, a two-terminal memory cell can be configured to store data as a plurality of conductivity profiles and to change conductivity when exposed to an appropriate voltage drop across the two-terminals. The memory cell can include an electrolytic tunnel barrier and a mixed ionic-electronic conductor in some embodiments, as well as multiple mixed ionic-electronic conductors in other embodiments. A voltage drop across the electrolytic tunnel barrier can cause an electrical field within the mixed ionic-electronic conductor that is strong enough to move trivalent mobile ions out of the mixed ionic-electronic conductor, according to some embodiments.

In some embodiments, an electrolytic tunnel barrier and one or more mixed ionic-electronic conductor structures do not need to operate in a silicon substrate, and, therefore, can be fabricated above circuitry being used for other purposes. For example, a substrate (e.g., a silicon—Si wafer) can include active circuitry (e.g., CMOS circuitry) fabricated on the substrate as part of a front-end-of-the-line (FEOL) process. After the FEOL process is completed, one or more layers of two-terminal cross-point memory arrays are fabricated directly over the active circuitry on the substrate as part of a back-end-of-the-line process (BEOL). The BEOL process includes fabricating the conductive array lines and the memory cells that are positioned at cross-points of the conductive array lines (e.g., row and column conductive array lines). An interconnect structure (e.g., vias, thrus, plugs, damascene structures, and the like) can be used to electrically couple the active circuitry with the one or more layers of cross-point arrays. The interconnect structure can be fabricated FEOL. Further, a two-terminal memory cell can be arranged as a cross-point such that one terminal is electrically coupled with an X-direction line (or an “X-line”) and the other terminal is electrically coupled with a Y-direction line (or a “Y-line”). A third dimensional memory can include multiple memory cells vertically stacked upon one another, sometimes sharing X-direction and Y-direction lines in a layer of memory, and sometimes having isolated lines. When a first write voltage, VW1, is applied across the memory element (e.g., by applying ½ VW1 to the X-direction line and ½ −VW1 to the Y-direction line), the memory cell can switch to a low resistive state. When a second write voltage, VW2, is applied across the memory cell (e.g., by applying ½ VW2 to the X-direction line and ½ −VW2 to the Y-direction line), the memory cell can switch to a high resistive state. Memory cell using electrolytic tunnel barriers and mixed ionic-electronic conductors can have VW1 opposite in polarity from VW2.

It is desirable for a non-volatile re-writeable memory device to permit block erase and page programming for backward compatibility (e.g., with FLASH memory) and large file handling as well as partial page writes for optimal small file handling. It is also desirable for a storage system that employs the non-volatile re-writeable memory device to decide which method of data operation to use for storing data (e.g., block write, page program, or partial page write) based on commands or signals received by the storage system (e.g., from a host system in communication with the storage system).

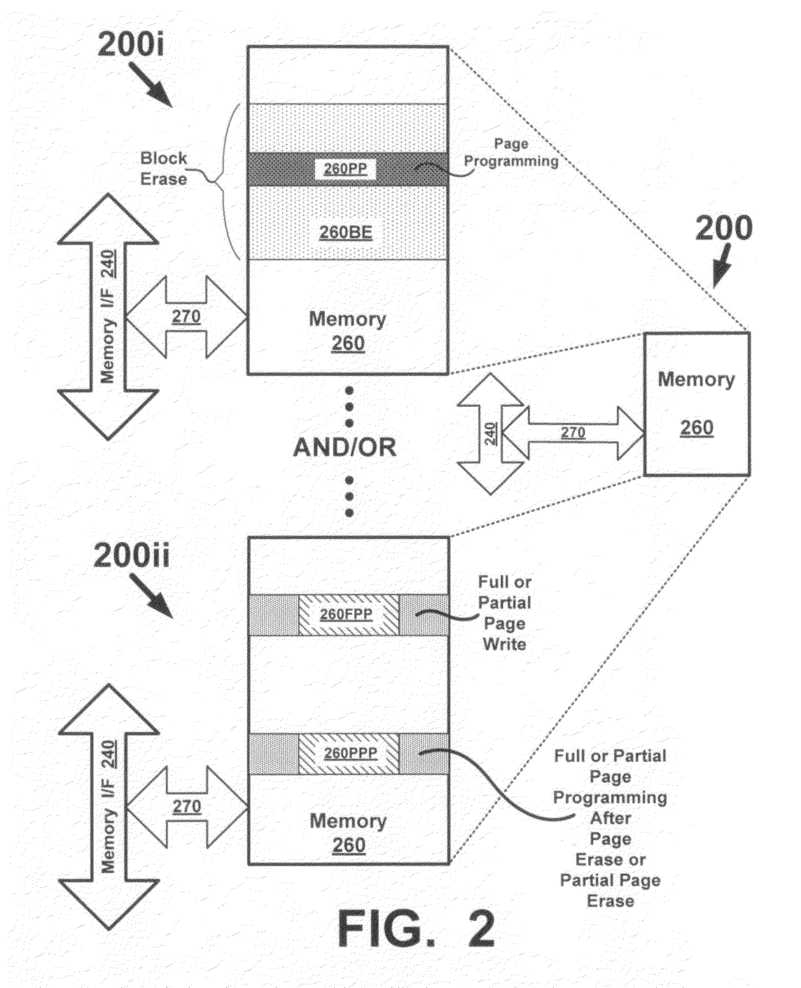

Turning now to FIG. 2, a scenario 200 for a non-volatile re-writeable memory device 260 (memory 260 hereinafter) depicts the memory 260 electrically coupled 270 with a memory interface (I/F) 240 operative to electrically communicate signals for: data operation commands; address; data; commands; and other signals necessary for data operations on the memory 260. The memory I/F 240 can be electrically coupled with a storage system, a controller (e.g., a memory controller), or some other device (not shown). The memory 260 is configured to retain stored data in the absence of power and for random access to address locations within the memory for data operations such as read, write, erase, and program. The memory 260 can be configured to emulate one or more types of memory such as SRAM, DRAM, FLASH, hard disk drives (HD), and non-FLASH based solid state drives (SSD), that is SSD's that do not use FLASH for non-volatile memory.

A scenario 200i depicts one method of data operations on the memory 260 including block erase 260BE and page programming 260PP so that the memory 260 is backward compatible with storage systems that utilize block erase and page programming, particularly in connection with large file handling. For example, even though the memory 260 is configured to perform a random access write without having to perform an erase operation (e.g., a block erase) prior to the write operation, there may be some storage systems applications that utilize block erase prior to a write operation, such as a system based on conventional FLASH memory technology, where a command for a write operation (e.g., from a host system) triggers a block erase command operative to erase a block of data prior to writing data to a location in memory 260. Typically, block erase and write operations are effectuated using software (e.g., a FLASH operating system—FLASH OS) operating in conjunction with circuitry in response to the write command. One disadvantage of the conventional block erase operation is that it requires additional time and therefore increases latency. However, in that the memory 260 does not require the erase operation prior to the write operation, access circuitry and/or software receiving the block erase 260BE command can be configured to mimic the block erase 260BE command by executing the appropriate handshakes that indicate the block erase 260BE command was executed even though the block erase 260BE command is disregarded (i.e., is not executed) (e.g., block erase 260BE is treated as a NOOP). Therefore, the NOOP is transparent to the entity requesting the data operation and the write operation proceeds as if the erase operation actually occurred prior to the write operation.

A scenario 200ii depicts another method of data operations on the memory 260 including a full or partial page write denoted as 260FPP and a full or partial page programming after a page erase or a partial page erase denoted as 260PPP. The full or partial page write 260FPP can occur without a prior erase operation on the memory 260. Therefore, a system, controller, or other device controlling data operations on the memory 260 over memory I/F 240 need not issue an erase command prior to the full or partial page write 260FPP operation; therefore, reducing latency and decreasing the time and complexity associated with writing small file sizes. The full or partial page programming after a page erase or a partial page erase 260PPP operation includes a prior page erase or a partial page erase operation and its associated command (e.g., from a controller) before the full or partial page programming operation. Therefore, a set of commands for 260PPP can include: a full page program command; a partial page program command; a page erase command; and a partial page erase command. As one example, a sequence of commands to memory 260 in scenario 200ii can include a first command for an erase operation and a second command for a full page program command or a partial page program command.

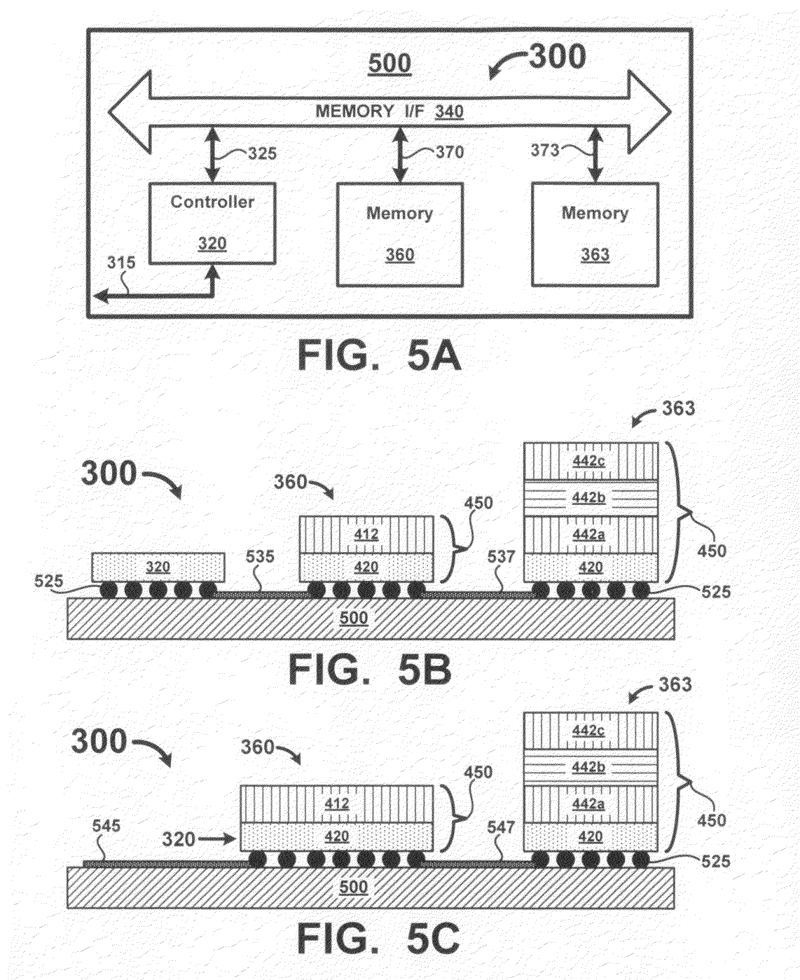

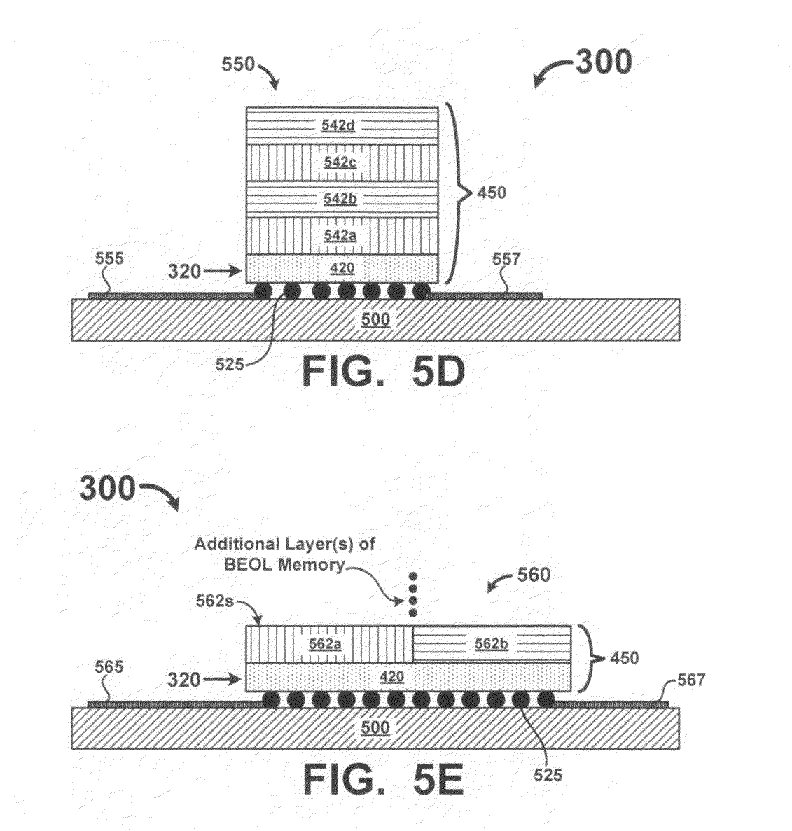

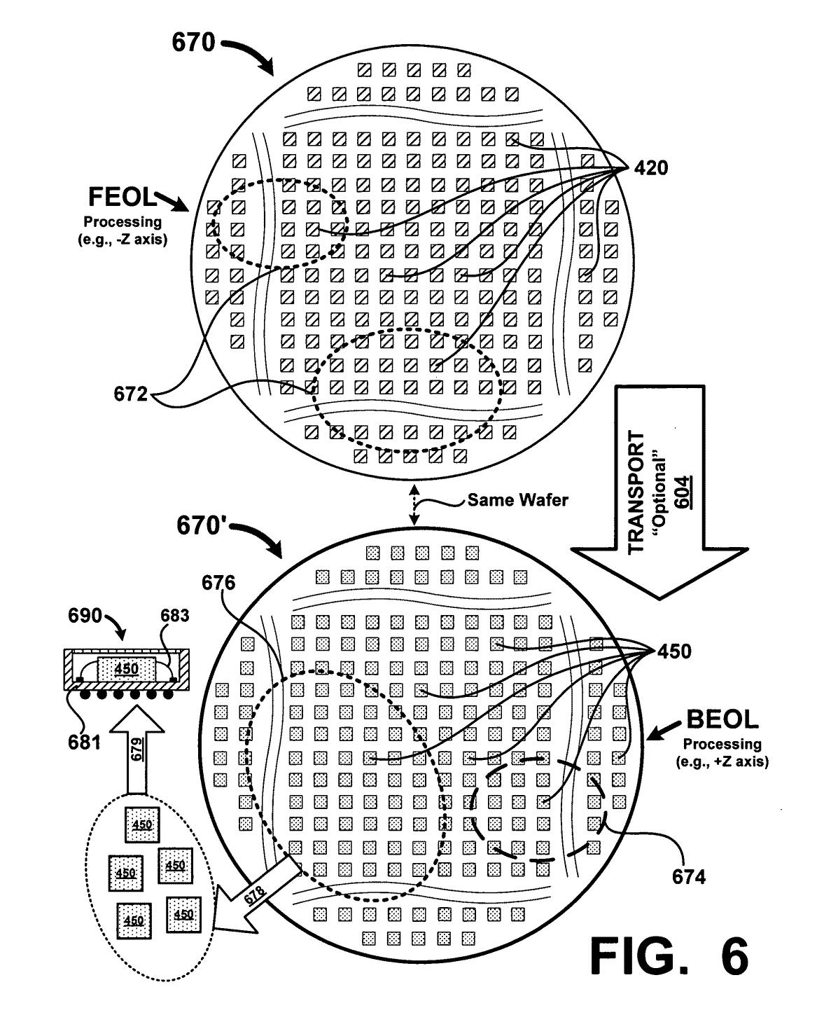

A host system (not shown) in electrical communication with the memory I/F 240 can use an interface for a data storage system to perform data operations on the memory 260 in scenarios 200i and/or 200ii. For example the interface can conform to interface protocols for mass storage devices, such as a hard disk drive (HD) and hybrid hard drives (HHD). HD and HHD use storage-interfaces such as serial ATA (e.g., SATA or eSATA), PCI Express (e.g., PCIe or PCI-e), universal serial bus (USB), IEEE-1394 (e.g., FireWire), or some other interface protocol. The memory 260 can be an integrated circuit (IC) configured as a solid state drive (SSD) or can be a data storage component in a SSD that includes a separate memory controller IC or an integrated memory controller (See FIGS. 5A-5E). Technically a SSD is not a HD or HHD because it has no rotating magnetic media for storing data; however, SSD's are typically configured to replace HD's and HHD's and use interface protocols for HD's and HHD's. Advantages to using one or more of the memories 260 in a SSD include lower power consumption compared to that of HD's and FLASH based SSD's and lower latency for data operations, especially for write operations when compared to SSD's based on FLASH memory technology. Additional applications that may be well suited for the memory 260 include but are not limited to mobile storage using embedded storage devices such as embedded MMC (eMMC), embedded secure digital (eSD), and universal flash storage (UFS).

The memory 260 in scenario 200 is configured to perform the data operations in scenario 200i and/or in scenario 200ii such that backward compatibility with large file handling and partial writes for optimal small file handling are handled by the same memory 260. Although only one memory 260 is depicted in FIG. 2, additional memories can be in electrical communication with memory I/F 240 and those memories can implement the scenario 200i, the scenario 200ii, or both.

Moving on to FIG. 3, a data storage system 300 includes host I/F 315, memory I/F 340, a controller 320 electrically coupled with host I/F 315 and electrically coupled 325 with memory I/F 340, and a plurality of memories 360 and 363 electrically coupled (370, 373) with memory I/F 340 and in electrical communication with controller 320 via memory I/F 340. The controller 320 can include a processor unit μP 330, a command decode unit CMD Decode 341, and a DMA/Sequencer unit 343. The μP 330 can be any processor unit and need not be a microprocessor (μP). For example, the μP 330 can be a microcontroller or a DSP. The CMD Decode 341 can be configured to decode commands (e.g., commands for data operations) communicated to the controller 320 via host I/F 315.

Depending on the type of data operation being performed and the size of data to be written to the plurality of memories, the memory 360 can implement the aforementioned block erase 260BE and page programming 260PP (e.g., for large file sizes) and the memory 363 can implement the aforementioned full or partial page write 260FPP and full or partial page programming after a page erase or partial page erase 260PPP (e.g., for small file sizes). Although not depicted in FIG. 3, the manner in which the memories 360 and 363 store data from data operations can change such that, for some data operations, the memory 360 can implement the full or partial page write 260FPP and full or partial page programming after a page erase or partial page erase 260PPP. Whereas, memory 363 can implement the block erase 260BE and page programming 260PP. In some data operations, both memories 360 and 363 can implement the full or partial page write 260FPP and full or partial page programming after a page erase or partial page erase 260PPP, or in other data operations, both memories 360 and 363 can implement the block erase 260BE and page programming 260PP.

As denoted by the dashed lines, a portion of the data storage system 300 can be fabricate FEOL and the memories 360 and 363 can be fabricated BEOL on top of the FEOL portion of the data storage system 300. As was described above, the FEOL portion can include active circuitry fabricated on a substrate (e.g., a silicon—Si wafer) and the active circuitry can include the controller 320 and its associated components 340, 341, 343, and other components required for storing and retrieving data from the memories in electrical communication with memory I/F 340. The plurality of memories 360 and 363 can be formed BEOL in a single layer or multiple layers that are vertically stacked over a base layer as will be described in greater detail below. As will be descried in greater detail below, the actual configuration for the data storage system 300 will be application specific and can comprise a plurality of IC's such as at least one IC for the controller 320 and its associated components 340, 341, 343 and one or more IC's for non-volatile memory storage such as memories 360 and 363. If a separate IC for the controller 320 or an external controller is used, then the controller need not be fabricated FEOL as described above. For example, the IC for the controller 320 and the IC's for the memories 360 and 363 can be mounted to a substrate (e.g., a PC board or the like) and electrically coupled with one another using electrically conductive traces.

For the data storage system 300, upon receipt of a command and/or one or more signals (e.g., via host I/F 315), the command is decoded by CMD decode 341 to determine if a write operation is needed based on the command. If a write operation is needed, then the amount of data to be transferred is determined. If the amount of data to be transferred is greater than or equal to the block erase size (e.g., ≧128 KB), then controller 320 initiates the aforementioned backward compatible block erase 260BE and page programming 260PP method.

On the other hand, if the amount of data to be transferred is less than the block erase size, then the controller 320 initiates the data transfer to the memory 360 and/or 363 using the full or partial page write 260FPP method. A full page write as opposed to a partial page write can be implemented if the full page write is the most efficient method for performing the write operation to the memories 360 and/or 363.

The data operation features depicted in scenarios 200i and 200ii can be implemented in a variety of ways. As one example, a host system (not shown) can issue a command for a data operation that is received by controller 320 and decoded by CMD decode 341. The data operation can be a discrete erase-program operation with a page erase command (e.g., 68h-D0h) and a conventional page program command (e.g., 80h-10h). As another example, the host system can issue a command for a combined page write operation, such as page write command (F0h-90h). The reason for the two implementations is that the controller 320 can determine that in some cases it is more convenient to perform a page erase immediately, and then wait for the page data to program at a later time. Alternatively, the controller 320 can determine that it is more convenient to perform the page write as a single operation with only one page write command. In some embodiments, both implementations will be used to increase system flexibility. The above commands are only examples and actual commands will be application dependent. The actual commands used can be identical to conventional commands, can be new commands, can be application specific commands, or a combination of the foregoing.

In that the memory described in FIGS. 2-6 is fully randomly accessible and does not require an erase operation (e.g., a block erase operation) prior to a write operation, nothing precludes a command or commands that perform data operations on units of memory having a granularity smaller than blocks and pages. For example, a read or write of a unit of data as small as a single bit of data or larger (e.g., a word, a byte, a nibble) can be performed. The unit of data need not be a standard unit such as a word, a byte, or a nibble, but can be a single bit, an odd number of bits, an even number of bits, etc. In some applications, one or more bits in a block, a page, a word, a byte, a nibble, or some other unit of data can be written or read and those bits need not be contiguous bits. For example, in a 32-bit word including bits 0-31, bits at positions 2, 6, 7, 15, and 29 in the 32-bit word can be directly accessed for a read or write operation. As another example, bytes or nibbles within a word can be read or written.

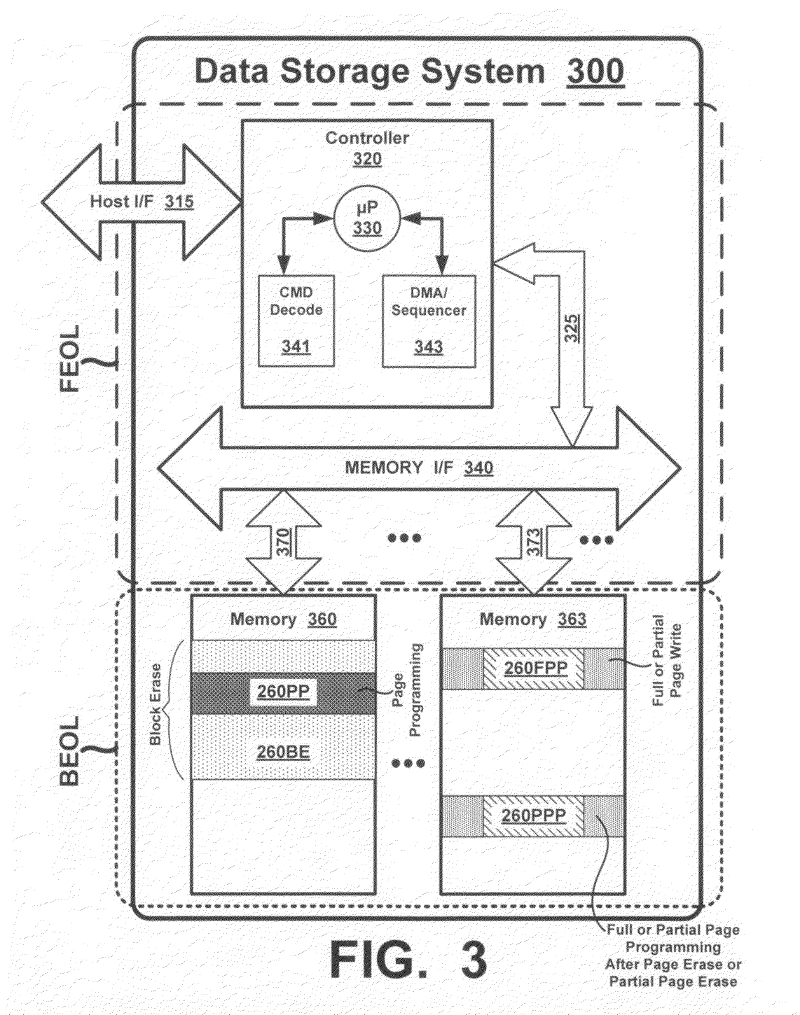

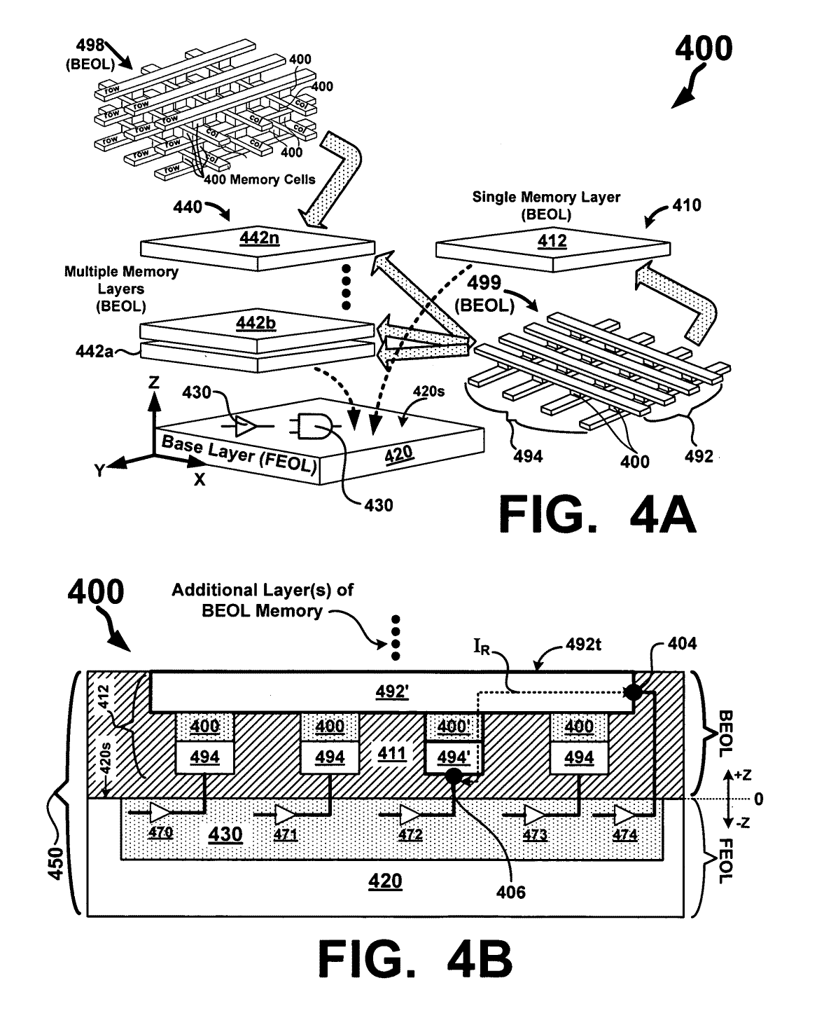

Turning now to FIG. 4A, an integrated circuit 400 can include non-volatile and re-writable memory cells 400 disposed in a single layer 410 or in multiple layers 440 of memory, according to various embodiments of the invention. In this example, integrated circuit 400 is shown to include either multiple layers 440 of memory (e.g., layers 442a, 442b, . . . 442n) or a single layer 410 of memory 412 formed on (e.g., fabricated directly above) a base layer 420 (e.g., a silicon wafer). In at least some embodiments, each layer of memory (412, or 442a, 442b, . . . 442n) can include a two-terminal cross-point array 499 having conductive array lines (492, 494) arranged in different directions (e.g., substantially orthogonal to one another) to access memory cells 400 (e.g., two-terminal memory cells). For example, conductors 492 can be X-direction array lines (e.g., row conductors) and conductors 494 can be Y-direction array lines (e.g., column conductors). The array 499 and the layers of memory 412, or 442a, 442b, . . . 442n can be fabricated back-end-of-the-line (BEOL) directly on top of an upper surface 420s of the base layer 420. Base layer 420 can include a bulk semiconductor substrate upon which circuitry, such as memory access circuits (e.g., controllers, memory controllers, DMA circuits, μP, DSP, address decoders, drivers, sense amps, etc.) can be formed as part of a front-end-of-the-line (FEOL) fabrication process. For example, base layer 420 can be a silicon (Si) substrate or some other semiconductor substrate or wafer upon which the active circuitry 430 is fabricated. The active circuitry 430 can include analog and digital circuits configured to perform data operations on the memory layer(s) that are fabricated above the base layer 420 and optionally configured to communicate with an external system(s) that electrically communicate with the active circuitry 430 in the base layer 420. An interconnect structure (not shown) including vias, plugs, thrus, and the like, can be used to electrically communicate signals from the active circuitry 430 to the conductive array lines (492, 494). Some or all of the circuitry depicted in FIG. 3, can be fabricated on the base layer 420. In some implementations, some or all of the circuitry depicted in FIG. 3 can be fabricated on some other device or substrate. The memory depicted in FIGS. 2 and 3 can be disposed in a single layer (e.g., 412) or in multiple layers (e.g., 442a, 442b, . . . 442n). In some applications, the memory depicted in FIGS. 2 and 3 can be disposed in one or more two-terminal cross-point arrays (e.g., 499) that are disposed in one layer of memory or disposed in multiple layers of memory (see FIGS. 5B-5E). In other applications, an address space for a single array (e.g., 499) can be partitioned (e.g., via hardware and/or software) to mimic two or more memories (e.g., memory 360 and memory 363).

Reference is now made to FIG. 4B, where integrated circuit 400 includes the base layer 420 and active circuitry 430 fabricated directly on top of the base layer 420. As one example, the base layer 420 can be a silicon (Si) wafer and the active circuitry 430 can be microelectronic devices formed on the base layer 420 using a CMOS fabrication process. The memory cells 400 and their respective conductive array lines (492, 494) can be fabricated directly on top of the active circuitry 430 in the base layer 420, such that a die 450 comprises a unitary whole that includes a first portion of the die 450 that is fabricated FEOL to form the active circuitry 430 and a second portion of the die 450 comprising the layer(s) of memory 412 that are fabricated BEOL directly on top of the first portion of the die 450. Although not depicted, the second portion for the BEOL can include multiple layers of memory that are vertically stacked above one another (e.g., array 498 and layers 442a, 442b, . . . 442n) as depicted in FIG. 4A. Those skilled in the art will appreciate that an inter-level interconnect structure (not shown) can electrically couple the conductive array lines (492, 494) with the active circuitry 430 and the inter-level interconnect structure can include several metal layers. For example, vias can be used to electrically couple the conductive array lines (492, 494) with the active circuitry 430. The active circuitry 430 may include but is not limited to address decoders, sense amps, memory controllers, data buffers, direct memory access (DMA) circuits, voltage sources for generating the read and write voltages, DSPs, μPs, microcontrollers, registers, command decoders, counters, state machines, and clocks, just to name a few. Active circuits 470-474 can be configured to apply the select voltage potentials (e.g., read and write voltage potentials) to selected conductive array lines (492′, 494′). Moreover, the active circuitry 430 can be coupled with the conductive array lines (492′, 494′) to sense a read current I_{R} flowing through a selected memory cell 400′ during a read operation and the sensed current can be processed by the active circuitry 430 to determine the conductivity profiles (e.g., the resistive state) of the selected memory cells 400′. The memory cell 400 can be configured to store a single bit of data (e.g., 0 or 1) or multiple bits of data (e.g., two-bits for 00, 01, 10, and 11). If multiple bits of data are stored in a memory cell (e.g., as in MLC), then the sense amp circuitry can be configured for multi-level sensing (MLS). In some applications, it may be desirable to prevent un-selected array lines (492, 494) from floating. The active circuits 430 can be configured to apply an un-select voltage potential (e.g., approximately a ground potential) to the un-selected array lines (492, 494). A dielectric material 411 (e.g., SiO₂) can be used where necessary to provide electrical insulation between elements of the integrated circuit 400. Here, active circuits 472 and 474 apply select voltages at nodes 406 and 404 to select memory cell 400′ for a data operation. Although only one selected cell is depicted, the block and page operations described above will operatively select a plurality of memory cells 400 during a data operation to the memory (e.g., 260, 360, 363). If multiple layers of memory are implemented in the integrated circuit 400, then those additional layers (e.g., layers 442a, 442b, . . . 442n) can be fabricated above the layer depicted in FIG. 4B, that is, above a surface 492t of array line 492′. In some applications using vertically stacked memory arrays, each layer of memory is electrically isolated (e.g., using a dielectric materials such as 411) from one another. In other applications, memory cells 400 in adjacent memory layers share one or more conductive array lines with a memory cell 400 in the layer above it, below it, or both above and below it (e.g., see array 498 in FIG. 4A).

One skilled in the art will understand that the die 450 can be one of a plurality of die 450 that are part of a larger silicon wafer, such as a 300 mm silicon wafer, for example. Initially, as part of the FEOL fabrication process, each die 450 comprises only its respective active circuitry and interlevel interconnect structure. Subsequently, the same FEOL wafer receives additional BEOL processing to fabricate the memory layer 412 or multiple memory layers (e.g., layers 442a, 442b, . . . 442n) directly on top of the FEOL die to form a completed die 450 that is a unitary whole that includes the aforementioned first and second portions. After the BEOL processing is completed, the die 450 can be tested for functionality and yield using automatic test equipment and subsequently singulated (e.g., sawed or cut from the wafer) to separate each die 450 from the wafer in preparation for packaging in a suitable IC package or for sell to a third party.

Turning now to FIG. 5A, data storage system 300 can be mounted on a substrate 500 (e.g., a PC board or the like) and can comprise a controller IC 320 and one or more non-volatile memory IC's (two IC's 360 and 363 are depicted) mounted to the substrate 500. Controller 320 is electrically coupled with host I/F 315 and memory I/F 340 via 325 and the memories 360 and 363 are electrically coupled (370, 373) with memory I/F 340 and are in electrical communication with controller 320 via memory I/F 340. One skilled in the art will appreciate that the electrical communication can be accomplished using electrically conductive structures such as PC board traces or the like.

Moving now to FIG. 5B, a cross-sectional view of one possible configuration for the data storage system 300 includes a separate controller IC 320, memory IC 360 including a die 450 comprised of a FEOL base layer 420 with active circuitry and one layer of BEOL non-volatile memory 412 fabricated directly on top of base layer 420, and memory IC 363 including a die 450 comprised of a FEOL base layer 420 with active circuitry and three vertically stacked layers of BEOL non-volatile memory 422a-c fabricated directly on top of base layer 420. The components 320, 360, and 363 can be mounted and electrically coupled with the substrate 500 using an electrically conductive structure 525 such as solder bumps or surface mount technology, for example. Electrically conductive structures 535 and 537 can represent PC board traces that electrically couple the components 320, 360, and 363 with one another and with other systems that need to communicate with components 320, 360, and 363. The active circuitry in base layers 420 of non-volatile memory IC's 360 and 363 can be implemented in a variety of ways including but not limited to a state machine and an ASIC. In that IC 363 includes multiple layers of non-volatile memory, the active circuitry 420 in IC 363 can be different than that of IC 360.

Referring now to FIG. 5C, a cross-sectional view of another possible configuration for the data storage system 300 includes IC's 360 and 363, where IC 360 includes circuitry for the aforementioned controller 320 fabricated FEOL in it's base layer 420 and the single layer of non-volatile memory 412 fabricated BEOL on top of the controller 320 and additional active circuitry in base layer 420, such as active circuitry for data operations on memory 412. IC 363 includes base layer 420 and three vertically stacked layers of BEOL non-volatile memory 422a-c fabricated directly on top of base layer 420. Electrically conductive structures 545 and 547 can represent PC board traces that electrically couple the components 360 and 363 with each another and with other systems that need to communicate with components 360 and 363. Here, circuitry for controller 320 is positioned in IC 360 and serves as a memory controller for IC 360 and its single layer of memory 412 and for IC 363 and its three vertically stacked layers of memory 422a-c.

Turning now to FIG. 5D, a cross-sectional view of yet another possible configuration for the data storage system 300 includes IC 550 comprised of a die 450 including a FEOL base layer 420 that includes the circuitry for controller 320 and four BEOL layers of vertically stacked non-volatile memory 542a-d fabricated directly on top of base layer 420. Base layer 420 also includes active circuitry for performing data operations on the layers of memory 542a-d. Electrically conductive structures 555 and 557 can represent PC board traces that electrically couple IC 550 with other systems that need to communicate with IC 550.

In FIG. 5E, a cross-sectional view of another configuration for data storage system 300 includes IC 560 comprised of a die 450 including a FEOL base layer 420 that includes the circuitry for controller 320 and a single layer of horizontally partitioned non-volatile memory including a memory 562a and a memory 562b that are fabricated BEOL on top of base layer 420; however, unlike the prior examples, memories 562a and 562b are fabricated BEOL on the same plane and are not vertically stacked relative to each other. Although only two arrays are depicted, the example of FIG. 5E can include more than two non-volatile memory arrays that are horizontally partitioned on the same memory layer or plane, that is, they are physically disposed on the same layer. Furthermore, the example depicted in FIG. 5E can be modified to include additional vertically stacked layers of memory fabricated above a surface 562s memories 562a and 562b and those additional layers of memory can include horizontally partitioned memory arrays.

In FIGS. 5A-5E, the die 450 is not depicted in a package in order to better explain and illustrate the operation of the present invention. However, the die 450 can be disposed in any suitable package including but not limited to conventional packaging technology for IC,s, ASIC's, semiconductors, and new packaging technologies as they become available.

Attention is now directed to FIG. 6, where a top plan view depicts a single wafer (670, 670′) at two different stages of fabrication: FEOL processing on the wafer denoted as 670 during the FEOL stage of processing; and subsequently BEOL processing on the same wafer denoted as 670′ during the BEOL stage of processing. Wafer 670 includes a plurality of the base layer die 420 (see FIGS. 4A-4B) formed individually on wafer 670 as part of the FEOL process. As part of the FEOL processing, the base layer die 420 can be tested 672 to determine their electrical characteristics, functionality, performance grading, etc. After all FEOL processes have been completed, the wafer 670 is optionally transported 604 for subsequent BEOL processing (e.g., adding one or more layers of memory (e.g., layer 412, or layers 442a, 442b, . . . 442n) directly on top of surface 420s of each base layer die 420). During BEOL processing the wafer 670 is denoted as wafer 670′, which is the same wafer subjected to additional processing steps to fabricate the memory layer(s) directly on top of the base layer die 420. Base layer die 420 that failed testing can be identified either visually (e.g., by marking) or electronically (e.g., in a file, database, email, etc.) and communicated to the BEOL fabricator and/or fabrication facility. Similarly, performance graded base layer die 420 (e.g., graded as to frequency and/or speed of operation) may identified and communicated to BEOL the fabricator and/or fabrication facility. In some applications the FEOL and BEOL processing can be done by the same fabricator or performed at the same fabrication facility. The fabrication process can include more than one vendor performing the FEOL processing and/or more than one vendor performing the BEOL processing. Accordingly, the transport 604 may not be necessary and the wafer 670 can continue to be processed as the wafer 670′. The BEOL process forms the aforementioned memory layer(s) directly on top of the base layer die 420 to form a finished die 450 that includes the FEOL circuitry portion 420 along the −Z axis and the BEOL memory portion along the +Z axis (see FIGS. 4A-4B). The finished die 450 can be tested 674 and good and/or bad die identified. Subsequently, the wafer 670′ can be singulated 678 to remove die 450 (e.g., die 450 are precision cut or sawed from wafer 670′) to form individual memory device die 450. For example, the die 450 may subsequently be packaged by placing the die 450 into packages 681 and wire bonding 683 the die 450 to the package 681 to form integrated circuits 690 for mounting to a PC board or the like (not shown). Packaged memory devices 681 (e.g., die 450 mounted in a suitable IC package) can undergo additional testing to ensure functionality and yield. Here, the packaged memory device 690 can include the memory controller 320 or other active circuitry, such as a state machine for example, operative to receive commands for data operation, address, data, and other signals, and to perform the commanded data operations depicted in FIGS. 2 and 3 on the memory array(s). Although packaged die 450 are depicted, the present application is not limited to packaged die 450 and nothing precludes an unpackaged die 450 being mounted directly to a substrate (e.g., a PC board or a flexible substrate) using a suitable technology for attaching the die to the substrate.

The various embodiments of the invention can be implemented in numerous ways, including as a system, a process, an apparatus, or a series of program instructions on a computer readable medium such as a computer readable storage medium or a computer network where the program instructions are sent over optical or electronic communication links. In general, the steps of disclosed processes can be performed in an arbitrary order, unless otherwise provided in the claims.

The foregoing description, for purposes of explanation, uses specific nomenclature to provide a thorough understanding of the invention. However, it will be apparent to one skilled in the art that specific details are not required in order to practice the invention. In fact, this description should not be read to limit any feature or aspect of the present invention to any embodiment; rather features and aspects of one embodiment can readily be interchanged with other embodiments. Notably, not every benefit described herein need be realized by each embodiment of the present invention; rather any specific embodiment can provide one or more of the advantages discussed above. In the claims, elements and/or operations do not imply any particular order of operation, unless explicitly stated in the claims. It is intended that the following claims and their equivalents define the scope of the invention.

What is claimed is:

1. A data storage system, comprising:
at least one non-volatile memory that does not require an erase operation on the at least one non-volatile memory prior to a write operation on the at least one non-volatile memory; and
access circuitry electrically coupled with a memory interface and the at least one non-volatile memory, the memory interface operative to electrically communicate signals for data operations on the at least one non-volatile memory with the access circuitry, and the access circuitry operative to perform the data operations on the at least one non-volatile memory, and
wherein the signals include one or more commands for data operations configured to operate on at least one page address within a block of data stored in the at least one non-volatile memory.

2. The data storage system of claim 1, wherein the at least one non-volatile memory comprises at least one back-end-of-the-line (BEOL) non-volatile memory and the access circuitry comprises front-end-of-the-line (FEOL) access circuitry positioned on a substrate that the at least one BEOL non-volatile memory is in contact with and is fabricated directly above.

3. The data storage system of claim 1, wherein the at least one non-volatile memory includes a plurality of two-terminal non-volatile memory cells operative to store at least one-bit of data as a plurality of conductivity profiles.

4. The data storage system of claim 1, wherein the one or more commands for data operations comprises a full page write.

5. The data storage system of claim 1, wherein the one or more commands for data operations comprises a partial page write.

6. The data storage system of claim 1, wherein the one or more commands for data operations comprises a full page program after a page erase.

7. The data storage system of claim 1, wherein the one or more commands for data operations comprises a partial page program after a page erase.

8. The data storage system of claim 1, wherein the one or more commands for data operations comprises a partial page program after a partial page erase.

9. The data storage system of claim 1, wherein the one or more commands for data operations comprises commands configured for data operations on FLASH memory and include an erase operation prior to a write operation.

10. The data storage system of claim 9, wherein the erase operation is a block erase on a block of data in the at least one non-volatile memory.

11. The data storage system of claim 9, wherein the write operation comprises a page program operation.

12. The data storage system of claim 9, wherein the erase operation on the at least one non-volatile memory is mimicked and does not occur, and wherein signals consistent with the erase operation having been consummated are generated by the access circuitry and communicated over the memory interface.

13. The data storage system of claim 1, wherein the at least one non-volatile memory comprises a component in a solid state drive (SSD).

14. The data storage system of claim 1, wherein the at least one non-volatile memory comprises a component in an embedded storage device.

15. A data storage system, comprising:
a controller electrically coupled with a host interface and a memory interface, the host interface operative to electrically communicate data operation signals between the controller and an external host system, and the controller operative to electrically communicate the data operation signals with the memory interface;
at least one non-volatile memory that does not require an erase operation on the at least one non-volatile memory prior to a write operation on the at least one non-volatile memory; and
access circuitry electrically coupled with the memory interface and the at least one non-volatile memory, the memory interface operative to electrically communicate the data operation signals from the controller to access circuitry, and the access circuitry operative to perform data operations on the at least one non-volatile memory based on the data operation signals, and
wherein the data operation signals include one or more commands for data operations configured to operate on at least one page address within a block of data stored in the at least one non-volatile memory.

16. The data storage system of claim 15, wherein the controller includes a processor, a command decoder electrically coupled with the processor and operative to decode commands communicated over the host interface, and a DMA sequencer electrically coupled with the processor.

17. The data storage system of claim 15, wherein the at least one non-volatile memory comprises at least one back-end-of-the-line (BEOL) non-volatile memory and the access circuitry comprises front-end-of-the-line (FEOL) access circuitry positioned on a substrate that the at least one BEOL non-volatile memory is in contact with and is fabricated directly above.

18. The data storage system of claim 15, wherein the one or more commands for data operations comprises a full page write.

19. The data storage system of claim 15, wherein the one or more commands for data operations comprises a partial page write.

20. The data storage system of claim 15, wherein the one or more commands for data operations comprises a full page program after a page erase.

21. The data storage system of claim 15, wherein the one or more commands for data operations comprises a partial page program after a page erase.

22. The data storage system of claim 15, wherein the one or more commands for data operations comprises a partial page program after a partial page erase.

23. A data storage system, comprising:
at least one non-volatile memory that requires an erase operation on the at least one non-volatile memory prior to a write operation on the at least one non-volatile memory; and
access circuitry electrically coupled with a memory interface and the at least one non-volatile memory, the memory interface operative to electrically communicate signals for data operations on the at least one non-volatile memory with the access circuitry, and the access circuitry operative to perform the data operations on the at least one non-volatile memory, and
wherein the signals include one or more commands for data operations configured to operate on at least one page address within a block of data stored in the at least one non-volatile memory.

24. A data storage system, comprising:
a controller electrically coupled with a host interface and a memory interface, the host interface operative to electrically communicate data operation signals between the controller and an external host system, and the controller operative to electrically communicate the data operation signals with the memory interface;
at least one non-volatile memory that requires an erase operation on the at least one non-volatile memory prior to a write operation on the at least one non-volatile memory; and
access circuitry electrically coupled with the memory interface and the at least one non-volatile memory, the memory interface operative to electrically communicate the data operation signals from the controller to access circuitry, and the access circuitry operative to perform data operations on the at least one non-volatile memory based on the data operation signals, and
wherein the data operation signals include one or more commands for data operations configured to operate on at least one page address within a block of data stored in the at least one non-volatile memory.
